(19) United States
(12) Patent Application Publication
(10) Pub. No.: US 2017/0190031 A1
(43) Pub. Date: Jul. 6, 2017

(54) Magnetic Socket

(71) Applicant: Chia-Lin Chen, Taichung City (TW)

(72) Inventor: Chia-Lin Chen, Taichung City (TW)

(21) Appl. No.: 15/356,634

(22) Filed: Nov. 20, 2016

(30) Foreign Application Priority Data
Jan. 6, 2016 (TW) 105100265

(51) Int. Cl. B25B 23/12; B25B 23/00; B25B 13/06

(52) U.S. Cl. CPC B25B 23/12; B25B 13/06; B25B 23/0035

(57) ABSTRACT

A magnetic socket contains: a body and at least one magnetic attraction element. The body includes a connection segment and a fitting section, the connection segment has a polygonal coupling orifice defined therein and configured to accommodate a socket wrench, and the fitting section has a locking orifice formed therein and configured to lock a screw or a nut made of metal, wherein the locking orifice is polygonal. The body further includes at least one through orifice arranged on the fitting section and communicating with the locking orifice, and each of the at least one magnetic attraction element is housed in each of the at least one through orifice. Thereby, the magnetic socket is driven by the socket wrench so as to rotatably lock or remove a screw or a nut, and the magnetic socket magnetically attracts the screw or the nut, after removing the screw or the nut.

### BACKGROUND OF THE INVENTION

Field of the Invention

The present invention relates to a magnetic socket which is driven by a socket wrench so as to rotatably lock or remove a screw or a nut, and the magnetic socket magnetically attracts the screw or the nut after removing the screw or the nut.

Description of the Prior Art

A conventional magnetic socket is driven by a socket wrench so as to rotatably lock or remove a screw or a nut, and the magnetic socket magnetically attracts the screw or the nut after removing the screw or the nut.

As illustrated in FIGS. 1 and 2, a conventional magnetic socket contains a body 10, a resilient element 50 secured between an inner wall of the body 10 and a fitting element 20, and a magnetic attraction 30 fixed on the fitting element 20.

However, the magnetic attraction element 30 and the fitting element 20 are driven by the resilient element 50, so the resilient element 50 cannot push the nut out of the magnetic socket, after removing the nut, and the nut is magnetically attracted by the magnetic attraction element 30, thus removing the nut from the magnetic socket inconveniently, as shown in FIG. 2.

The present invention has arisen to mitigate and/or obviate the afore-described disadvantages.

### SUMMARY OF THE INVENTION

The primary objective of the present invention is to provide a magnetic socket which is driven by a socket wrench so as to rotatably lock or remove a screw or a nut, and the magnetic socket magnetically attracts the screw or the nut after removing the screw or the nut.

To obtain the above objectives, a magnetic socket provided by the present invention contains: a body and at least one magnetic attraction element.

The body includes a connection segment and a fitting section, the connection segment has a polygonal coupling orifice defined therein and configured to accommodate a socket wrench, and the fitting section has a locking orifice formed therein and configured to lock a screw or a nut made of metal, wherein the locking orifice is polygonal.

The body further includes at least one through orifice arranged on the fitting section and communicating with the locking orifice, and each of the at least one magnetic attraction element is housed in each of the at least one through orifice.

The magnetic socket further contains a metal spring accommodated in the locking orifice, wherein the metal spring includes a compression section and a fixing section magnetically attracted by the at least one magnetic attraction element, wherein the compression section abuts against the locking orifice, and the fixing section corresponds to the at least magnetic attraction element.

Preferably, said each through orifice communicates with each of multiple planes on an inner wall of the locking orifice.

Preferably, a distance between an open end of the fitting section and said each through orifice is 0.8 mm to 1.2 mm

Preferably, said each magnetic attraction element extends out of an outer wall of the fitting section.

### BRIEF DESCRIPTION OF THE DRAWINGS

FIG. 1 is a cross sectional view showing the operation of a conventional magnetic socket.

FIG. 2 is another cross sectional view showing the operation of the conventional magnetic socket.

FIG. 3 is a perspective view showing the exploded components of a magnetic socket according to a first embodiment of the present invention.

FIG. 4 is a perspective view showing the assembly of the magnetic socket according to the first embodiment of the present invention.

FIG. 5 is a cross sectional view showing the assembly of the magnetic socket according to the first embodiment of the present invention.

FIG. 6 is another cross sectional view showing the assembly of the magnetic socket according to the first embodiment of the present invention.

FIG. 7 is a cross sectional view showing the operation of the magnetic socket according to the first embodiment of the present invention.

FIG. 8 is another cross sectional view showing the operation of the magnetic socket according to the first embodiment of the present invention.

FIG. 9 is also another cross sectional view showing the operation of the magnetic socket according to the first embodiment of the present invention.

FIG. 10 is a cross sectional view showing the assembly of a magnetic socket according to a second embodiment of the present invention.

FIG. 11 is another cross sectional view showing the assembly of the magnetic socket according to the second embodiment of the present invention.

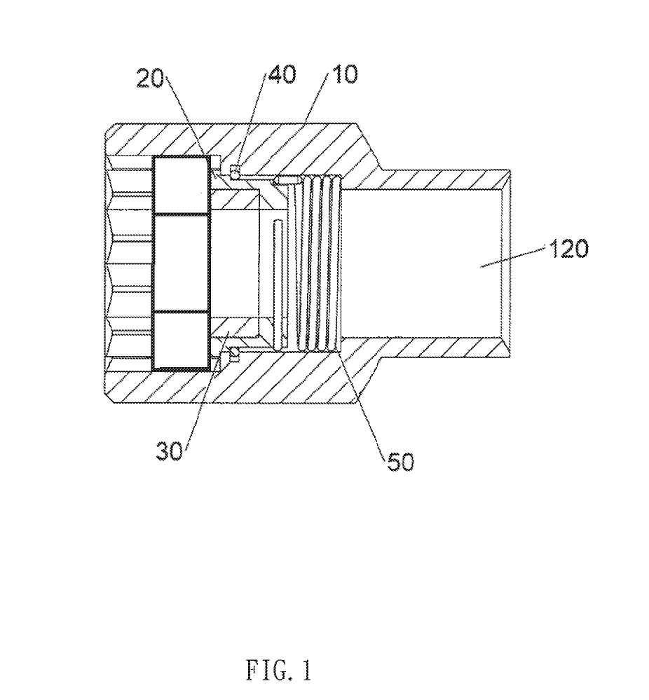

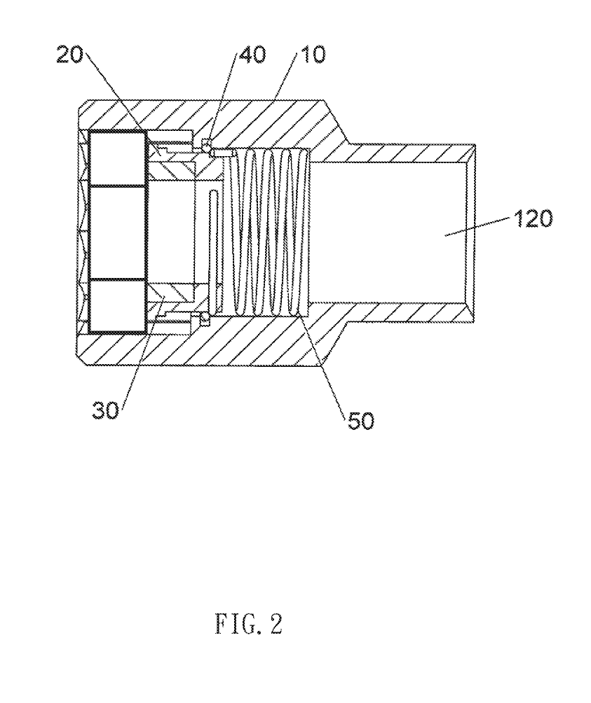

### DETAILED DESCRIPTION OF THE PREFERRED EMBODIMENTS

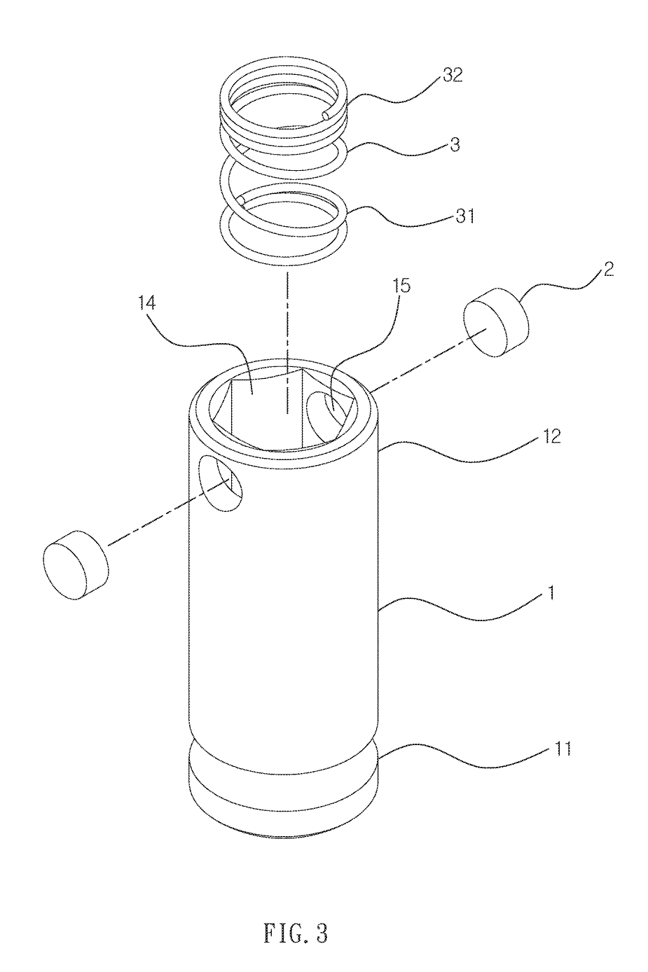

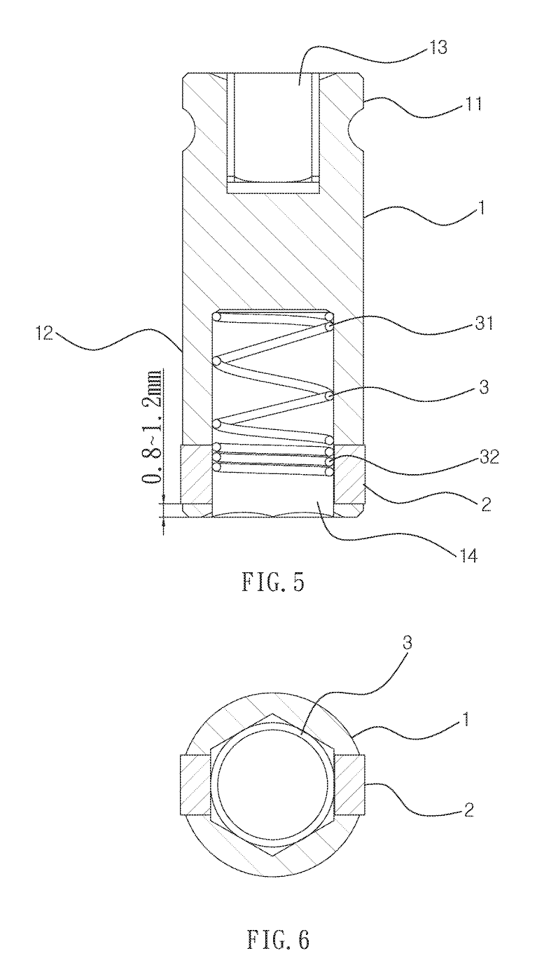

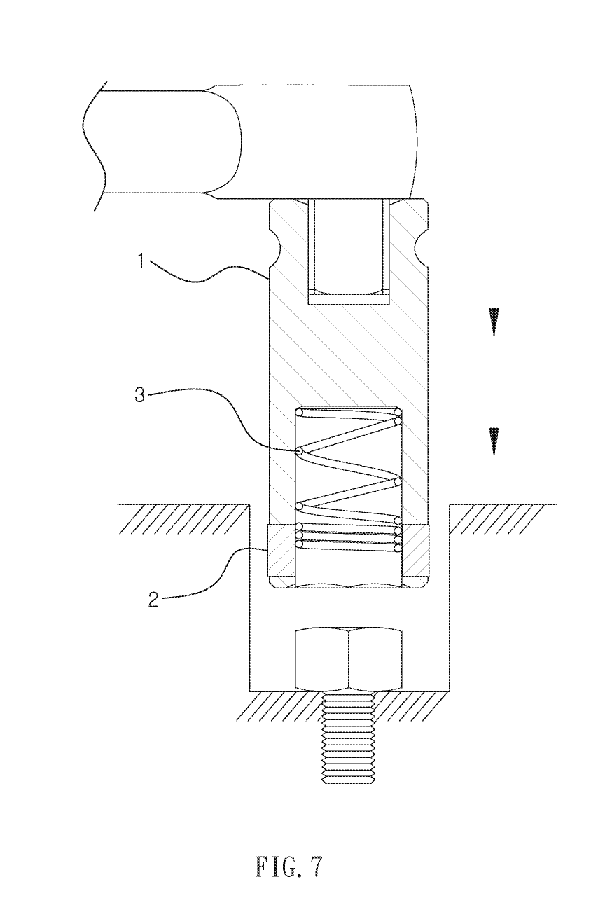

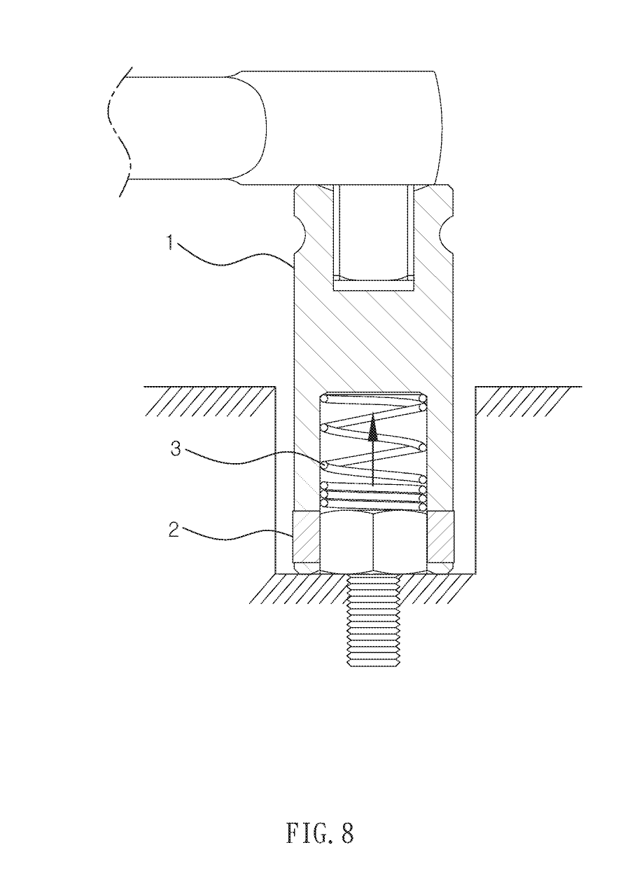

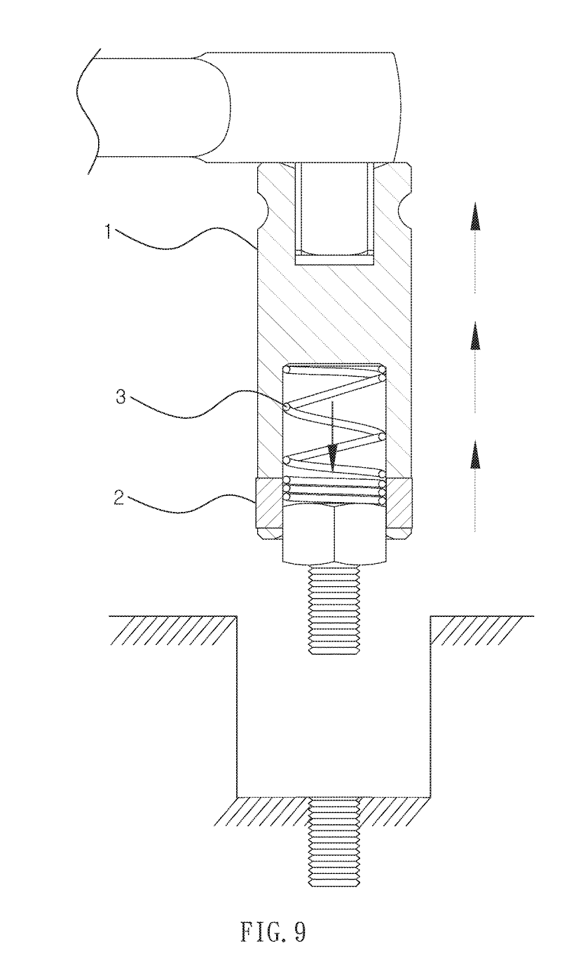

With reference to FIGS. 3 to 11, a magnetic socket according to a first embodiment of the present invention is driven by a socket wrench so as to rotatably lock or remove a screw or a nut, and the magnetic socket comprises: a body 1 and at least one magnetic attraction element 2.

The body 1 includes a connection segment 11 and a fitting section 12, wherein the connection segment 11 has a polygonal coupling orifice 13 defined therein and configured to accommodate the socket wrench, and the fitting section 12 has a locking orifice 14 formed therein and configured to lock the screw or the nut which is made of metal, wherein the locking orifice 14 is polygonal. The body 1 further includes at least one through orifice 15 arranged on the fitting section 12 and communicating with the locking orifice 14.

Each of the at least one magnetic attraction element 2 is housed in each of the at least one through orifice 15. In this embodiment, two magnetic attraction elements 2 are housed in two through orifices 15, respectively. Preferably, a number of the at least one magnetic attraction element 2 and the at least one through orifice 15 depends on using requirement.

Preferably, the at least one magnetic attraction element 2 corresponds to and magnetically attracts the screw or the nut, after removing the screw or the nut.

The magnetic socket further comprises a metal spring 3 accommodated in the locking orifice 14, and the metal spring 3 includes a compression section 31 and a fixing section 32 magnetically attracted by the at least one magnetic attraction element 2, wherein the compression section 31 abuts against the locking orifice 14, and the fixing section 32 corresponds to the at least magnetic attraction element 2, hence the metal spring 3 pushes the screw or the nut out of the magnetic socket. When the fixing section 32 of the metal spring 3 is not pressed, it corresponds to half of magnetic attraction area of said each magnetic attraction element 2, such that the metal spring 3 is magnetically attracted in the locking orifice 14 by said each magnetic attraction element 2, and the other magnetic area of said each magnetic attraction element 2 magnetically attracts the screw or the nut.

Preferably, said each through orifice 15 communicates with each of multiple planes on an inner wall of the locking orifice 14, hence said each magnetic attraction element 2 magnetically attracts the screw or the nut in the locking orifice 14 securely, after removing the screw or the nut.

A distance between an open end of the fitting section 12 and said each through orifice 15 is 0.8 mm to 1.2 mm, the screw or the nut is magnetically attracted by said each magnetic attraction element 2 securely, and the fitting section 12 has sufficient structure strength, after drilling said each through orifice 12.

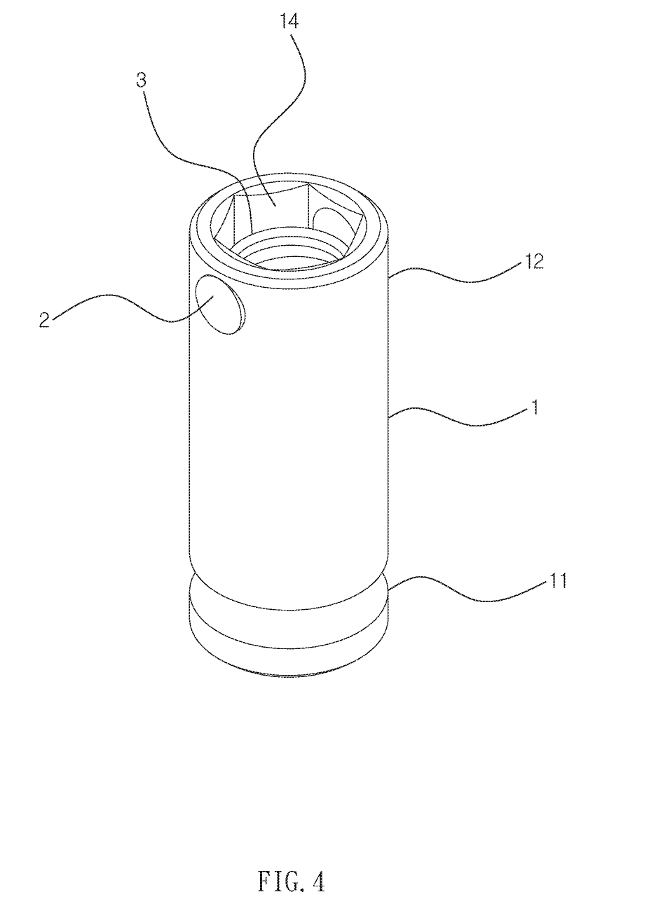

Referring to FIG. 4, said each magnetic attraction element 2 slightly extends out of an outer wall of the fitting section 12, hence the body 1 is fixed on a flat surface by way of said each magnetic attraction element 2.

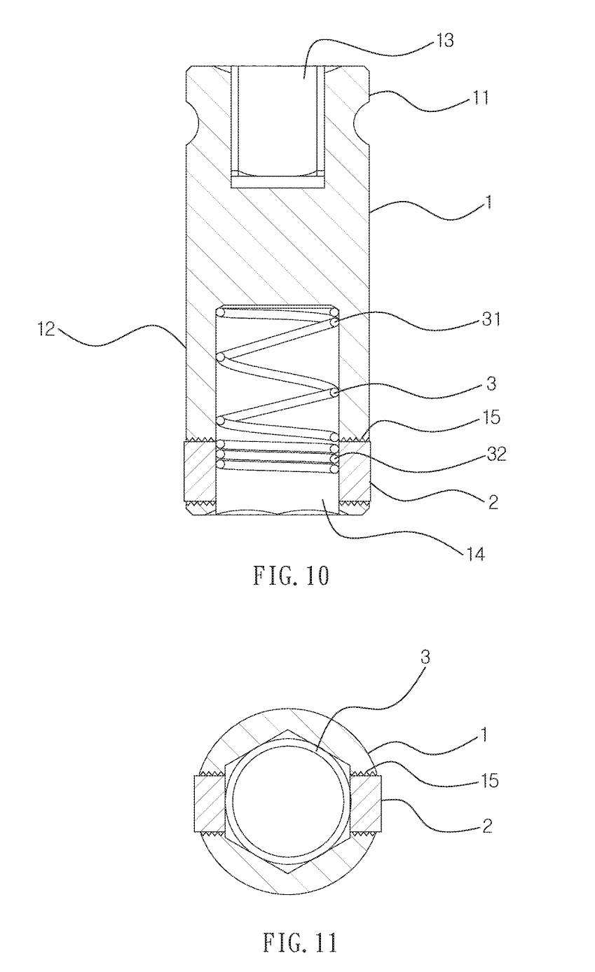

As shown in FIGS. 10 and 11, a difference of a magnetic socket of a second embodiment from that of the first embodiment comprises: at least one through orifice 15 arranged on a fitting section 12 of a body 1 and communicating with a locking orifice 14 of the fitting section 12, wherein each of the at least one through orifice 15 has threads formed therein so as to retain each of at least one magnetic attraction element 2 firmly.

Accordingly, as locking the screw into a screwing hole of a workpiece, a head end of the screw is housed in the locking orifice 14 so as to be magnetically attracted in the locking orifice 14 by said each magnetic attraction element 2, and when the magnetic socket is inserted into the screwing hole, it is not aligned with the screw again. After removing the screw, said each magnetic attraction element 2 magnetically attracts the screw so that the body 1 is removed from the screwing hole. Preferably, said magnetic attraction element 2 magnetically attracts the body 1 on a metal wall for storage.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A magnetic socket comprising: a body and at least one magnetic attraction element;
the body including a connection segment and a fitting section, wherein the connection segment has a polygonal coupling orifice defined therein and configured to accommodate a socket wrench, and the fitting section has a locking orifice formed therein and configured to lock a screw or a nut which is made of metal, wherein the locking orifice is polygonal;
wherein the body further includes at least one through orifice arranged on the fitting section and communicating with the locking orifice, and each of the at least one magnetic attraction element is housed in each of the at least one through orifice.

2. The magnetic socket as claimed in claim 1 further comprising a metal spring accommodated in the locking orifice, wherein the metal spring includes a compression section and a fixing section magnetically attracted by the at least one magnetic attraction element, wherein the compression section abuts against the locking orifice, and the fixing section corresponds to the at least magnetic attraction element.

3. The magnetic socket as claimed in claim 1, wherein said each through orifice communicates with each of multiple planes on an inner wall of the locking orifice.

4. The magnetic socket as claimed in claim 1, wherein a distance between an open end of the fitting section and said each through orifice is 0.8 mm to 1.2 mm

5. The magnetic socket as claimed in claim 1, wherein said each magnetic attraction element extends out of an outer wall of the fitting section.
